(19) United States
(12) Patent Application Publication
(10) Pub. No.: US 2023/0309448 A1
(43) Pub. Date: Oct. 5, 2023

(54) HARVESTING MACHINE FOR PROCESSING CROP AND METHOD FOR DETERMINING PROPERTIES OF CROP

(71) Applicant: SMF - HOLDING GMBH, Eichelhardt (DE)

(72) Inventor: Steffen GÜRKE, Windeck-Halscheid (DE)

(73) Assignee: SMF - HOLDING GMBH, Eichelhardt (DE)

(21) Appl. No.: 18/295,391

(22) Filed: Apr. 4, 2023

(30) Foreign Application Priority Data
Apr. 5, 2022 (EP) 22166806.4

(51) Int. Cl. A01D 41/127

(52) U.S. Cl. CPC A01D 41/1277

(57) ABSTRACT

A harvesting machine for cutting and processing crop, including a sensor arrangement, method for determining properties of crop when processing the crop with a harvesting machine, and method for determining properties of crop in a field.

### TECHNICAL FIELD

The application relates to a harvesting machine for processing crop, comprising a sensor arrangement, a method for determining properties of crop when processing the crop with a harvesting machine, and a method for determining properties of crop in a field.

### BACKGROUND

In today's harvesting machines, the analysis of the operating states of individual components of harvesting machines is becoming increasingly important. WO 2019/008071 Al discloses a method for analyzing the operating state of a cutterbar for mowing crop, the cutterbar having at least one mowing blade driven back and forth in a stroke direction H, and the mowing blade having cutting edges which cooperate with counter-cutting edges of the cutterbar, comprising the following method steps: detecting a signal representing the stroke position of the mowing knife, detecting a signal representing the knife force for driving the mowing knife as a function of the stroke position, and determining crop and/or cutting system properties on the basis of an evaluation of the signal representing the knife force as a function of the stroke position.

The assumption is made that changes in knife force are mainly caused by fluctuations in crop throughput. Other variables influencing the driving force of components, such as a straw toughness and a friction value of non-grain components are considered constant. If the real friction property and toughness of the crop varies, for example due to different maturity or weed growth, this affects the determined crop throughput as a measurement error. Thus, a throughput measurement based on the driving force of crop processing components is subject to measurement uncertainty.

An objective can be to provide a harvesting machine for processing crop and a method for determining properties of crop that enable more accurate determination of the properties of the crop.

### SUMMARY

The objective is achieved by a harvesting machine for cutting and processing crop and by two methods for determining properties of crop.

The harvesting machine for processing crops has a sensor arrangement with at least two of the following sensors for generating signals:

a cutting force sensor adapted to detect a force for driving at least one component of the harvesting machine cutting the crop and to generate a cutting force signal,

a friction force sensor adapted to detect a force for driving at least one component of the harvesting machine that conveys and/or processes the crop, and to generate a friction force signal,

a moisture sensor adapted to detect a moisture of the crop and to generate a moisture signal.

Furthermore, the harvesting machine has an evaluation device which is adapted to evaluate the signals generated by the at least two of the sensors and to determine a development of a straw toughness of the crop and/or a friction value of the crop on the basis of the evaluation.

The component cutting the crop can be, for example, a mower knife. Alternatively, a harvest header may be the component cutting the crop, wherein the force for driving the harvest header may also include proportional forces for conveying the crop in the harvest header, for example for conveying with a transverse auger. The cutting force sensor measures the force to drive the component cutting the crop. The cutting force signal is a signal representing the measured force to drive the component cutting the crop. Insofar as a proportion of the force measured by the cutting force sensor for driving the component cutting the crop can be attributed to conveying the crop, the proportion attributed to cutting predominates, accounting for at least two thirds of the measured force, for example.

The component conveying or processing the crop can be, for example, an inclined conveyor or a threshing drum. Alternatively, a threshing device may be the crop conveying and processing component, wherein the force to drive the threshing device includes both forces to convey and forces to process the crop. The friction force sensor measures the force to drive the component conveying and/or processing the crop. The friction force signal is a signal representing the measured force for driving the component conveying and/or processing the crop.

The moisture sensor measures a moisture of the crop. The moisture signal is a signal representing the measured moisture of the crop.

The evaluation device is, for example, a computer with which a program is executed to evaluate the signals. The evaluation device can record the evaluated signals in a storage medium. The signals are evaluated, for example, by algorithms or assignment tables defined in the program in order to assign the corresponding development of the straw toughness and the friction value of the crop to certain signal paths. The assignment can be based, for example, on an empirical evaluation of the signals. The evaluation device can be connected to a control device of the harvesting machine in order to intervene in a drive control of the components cutting and/or processing the crop or in an engine control on the basis of the determined development of the straw toughness and the friction value of the crop. For example, the travel speed of the harvesting machine can be adjusted. Alternatively or additionally, the determined development of the straw toughness and the friction value of the crop can be output, for example in visual and/or acoustic form, to inform an operator.

One advantage is that the setting of the travel speed and the crop cutting and processing components is not exclusively dependent on the throughput of crop, but also takes into account its threshing suitability in terms of straw toughness and friction value. Such an optimally adjusted harvesting machine can avoid threshing and/or quality losses and is less susceptible to blockages and crop flow disturbances. Unnecessary reductions in travel speed and crop throughput are avoided, allowing the performance potential of the harvesting machine to be exploited to advantage.

The sensor arrangement may further comprise a position sensor, wherein the position sensor is configured to detect a knife position of the component cutting the crop and to output a position signal. The evaluation device is further adapted, for example, to evaluate the cutting force signal as a function of the knife position of the component cutting the crop.

The first method for determining characteristics of crop when processing the crop with a harvesting machine comprises at least two of the following steps a, b, and c for generating signals:

a) detecting a force to drive at least one component of the harvesting machine cutting the crop and generating a cutting force signal;

b) detecting a force for driving at least one component of the harvesting machine conveying and/or processing the crop and generation of a friction force signal;

c) detecting a moisture of the crop and generation of a moisture signal; wherein the at least two generated signals are evaluated and wherein a development of a straw toughness of the crop and/or a friction value of the crop is determined based on the evaluated signals.

The second method for determining properties of crop in a field provides that preliminary information about the properties of the crop in a map of the field is matched with measurement data of the properties of the crop determined in the field during processing of the crop with a harvesting machine, wherein at least one of the following steps a, b and c for generating signals is carried out for determining the measurement data:

a) detecting a force for driving at least one component (6) of the harvesting machine cutting the crop and generating a cutting force signal;

b) detecting a force for driving at least one component (7) of the harvesting machine conveying and/or processing the crop and generation of a friction force signal,

c) detecting a moisture of the crop and generating a moisture signal; wherein the at least one generated signal is evaluated, and wherein a development of a straw toughness of the crop and/or a friction value of the crop is determined based on the evaluated signals.

An advantage is that the straw toughness and the friction value of non-grain components of the crop can be taken into account.

According to an embodiment of the second method, it is provided that a prediction map of the field with updated characteristics of the crop is created from the preliminary information and the measurement data.

According to a further embodiment of the second method, the prediction map is provided by means of a predictive model.

According to a further embodiment of the second method, it is provided that geographical information data on the location of the determination of the measurement data in the field is retrieved.

According to a further embodiment of the second method, it is provided that the field is divided into a finite number of areas with matching growth conditions on the basis of the preliminary information, wherein the measurement data determined for the first time in one of the areas are collated for the entire area with the preliminary information.

Embodiments described below refer both to the first method and the second method.

When evaluating the signals, according to an embodiment, the development of the straw toughness and/or the friction value can be inferred on the basis of a change and/or a direction of the change and/or a gradient of the change of the respective signal. Insofar as it is stated below that the development of the straw toughness and/or the friction value is inferred, this can be further processed as the determined development of the straw toughness and/or the friction value, for example in order to intervene in the drive control of the components cutting and/or processing the crop or in the motor control on the basis of the determined development. Alternatively or additionally, the determined development of the straw toughness and the friction value of the crop can be output, for example in visual and/or acoustic form, to inform the operator.

According to an embodiment, the signals can be evaluated repeatedly during an evaluation period, with the respectively determined development of the straw toughness and the friction value being output at the end of the evaluation period.

If, when evaluating the signals, a constant straw toughness and a constant friction value are determined, a change in the drive forces of the components of the harvesting machine can be inferred, for example, to a change in the throughput of crop. According to an embodiment, the change in crop throughput can be determined using the method described in WO 2019/008071 A1. If the change in the drive forces of the harvesting machine components is not due to the change in crop throughput or the change in straw toughness or friction value, this is an indication of a possible malfunction, which can thus be advantageously detected and rectified at an early stage.

According to a further embodiment, it is provided that the evaluation of the cutting force signal and the moisture signal is performed according to the following specifications:

with a change in the cutting force signal and a constant moisture signal, a constant straw toughness and a constant friction value is inferred;

in case of rectified changes of the cutting force signal and the moisture signal, a change of the straw toughness is inferred;

with a constant cutting force signal and a change in the moisture signal, a change in the friction value is inferred.

According to a further embodiment, it is provided that the evaluation of the cutting force signal and the friction force signal is performed according to the following specifications:

for changes in the cutting force signal and the friction force signal with the same change gradients, a constant straw toughness and a constant friction value are inferred;

in case of changes in the cutting force signal and the friction force signal, where a change gradient of the cutting force signal is greater than a change gradient of the friction force signal, a change in straw toughness is inferred;

in case of changes in the cutting force signal and the friction force signal, where a change gradient of the friction force signal is greater than a change gradient of the cutting force signal, a change in the friction value is inferred.

According to a further embodiment, it is provided that the evaluation of the cutting force signal, the friction force signal and the moisture signal is performed according to the following specifications:

in case of changes in the cutting force signal and the friction force signal with the same change gradients and with a constant moisture signal, a constant straw toughness and a constant friction value are inferred;

for changes in the cutting force signal and the friction force signal, where a change gradient of the cutting force signal is greater than a change gradient of the friction force signal, and for changes in the moisture signal, a change in straw toughness is inferred;

in case of changes in the cutting force signal and the friction force signal, where a change gradient of the friction force signal is greater than a change gradient of the cutting force signal, and in the case of a change in the moisture signal, a change in the friction value is inferred.

According to a further embodiment, it is provided that a knife position of the component cutting the crop is detected as a further parameter, wherein the evaluation of the cutting force signal is carried out taking the knife position into account. For example, the cutting force signal is only evaluated in knife positions where crop is being cut. Furthermore, in knife positions where no crop is being cut, the cutting force signal can be evaluated as a friction force signal indirectly representing the force to drive a component conveying the crop.

According to a further embodiment, it is provided that the detecting in steps a, b and c is performed with sensors, wherein at least two of the following sensors are used:

in step a, a cutting force sensor for detecting the force and generating the cutting force signal;

in step b, a friction force sensor for detecting the force and generating the friction force signal;

in step c, a humidity sensor for detecting the humidity and generating the humidity signal.

The crop can be processed with the harvesting machine described above.

In the following, both the method and the harvesting machine are explained in more detail by means of an embodiment with reference to the enclosed drawings.

### BRIEF DESCRIPTION OF THE DRAWINGS

FIG. 1 shows an embodiment of a harvesting machine in a schematic partial representation;

FIG. 2 shows an application example of a method for determining properties of crop.

### DETAILED DESCRIPTION

As required, detailed embodiments of the present invention are disclosed herein. It is to be understood that the disclosed embodiments are merely exemplary of the invention that may be embodied in various and alternative forms. The figures are not to scale; some features may be exaggerated or minimized to show details of particular components. Therefore, specific structural and functional details disclosed herein are not to be interpreted as limiting, but merely as a representative basis for teaching one skilled in the art to variously employ the present invention.

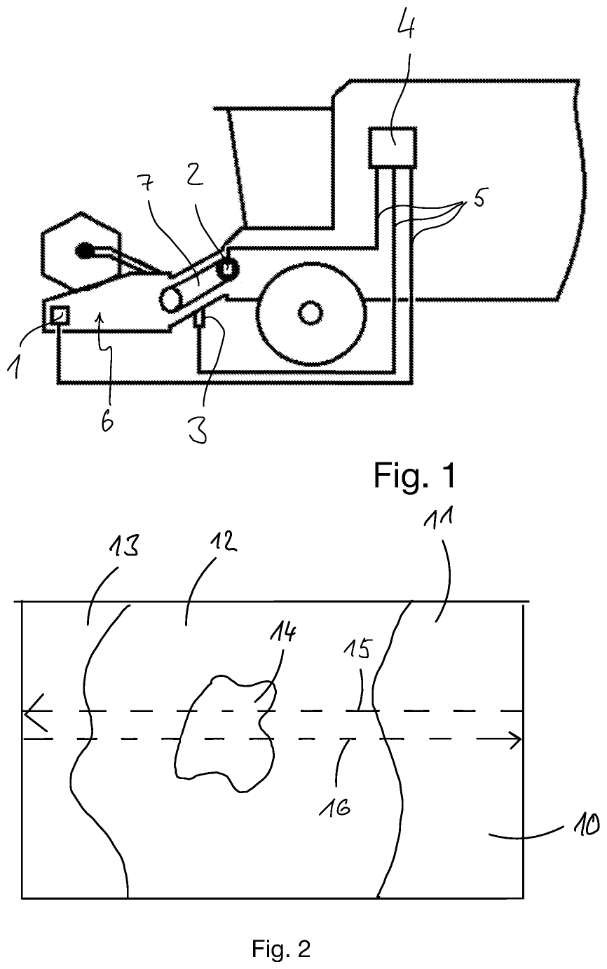

The agricultural harvesting machine shown schematically in FIG. 1 can be, for example, a combine harvesting machine, swather or forage harvester for processing crops. After cutting, the crop consisting of grain components and non-grain components can be separated by processing. The harvesting machine has a sensor arrangement with a cutting force sensor 1, a friction force sensor 2 and a moisture sensor 3, whereby each of the sensors 1, 2, 3 can also be present multiple times, for example to create redundancy. Furthermore, the harvesting machine has an evaluation device 4, which is set up to evaluate signals generated by the sensors 1, 2, 3, which are transmitted via data lines 5, for example, and to determine a development of a straw toughness of the crop and/or a friction value of the crop on the basis of the evaluation. At least two of the sensors 1, 2, 3 or the signals are required for evaluation. The sensor arrangement with the three sensors cutting force sensor 1, friction force sensor 2 and moisture sensor 3, and respectively the evaluation of all signals, advantageously allows a more precise determination of the straw toughness and/or the friction value. In addition, the evaluation of all signals allows a plausibility check of the signals for the detection of disturbances and a better differentiability of the friction and toughness changes with simultaneous changes of the material flow. For better differentiation of crop flow changes, a travel speed of the harvesting machine can also be processed as a travel speed signal in the evaluation device.

The cutting force sensor 1 is set up to detect a force for driving at least one component 6 of the harvesting machine that cuts the crop, and to generate a cutting force signal.

The component 6 cutting the crop can be, for example, a mower knife. Alternatively, a harvest header may be the component 6 cutting the crop.

The friction force sensor 2 is adapted to detect a force for driving at least one component 7 of the harvesting machine that conveys and/or processes the crop, and to generate a friction force signal. The component 7 conveying or processing the crop may be, for example, an inclined conveyor or a threshing drum (not shown). Alternatively, a threshing device may be the component 7 conveying and processing the crop.

The moisture sensor 3 is arranged to detect a moisture of the crop and generate a moisture signal. The moisture sensor 3 measures a moisture content of the crop, and the crop moisture content can be measured in the total throughput of grain components and non-grain components or in the partial throughput of non-grain components. Moisture measurement, for example, is based on a capacitive measurement principle. By means of an electric field built up in the crop stream, dielectric properties of the grain are measured, which are essentially determined by its water content with the density of the crop stream remaining constant.

The evaluation device 4 is, for example, a computer with which a program is executed to evaluate the signals.

Crop flow changes, i.e., changes in crop throughput and changes in the density of the crop stream, can affect the measurements of the cutting force sensor 1, the friction force sensor 2, and the moisture sensor 3. These can be compensated for during evaluation with the evaluation device 4.

The method for determining characteristics of the crop during processing by the harvesting machine includes at least two of the following steps a, b, and c for generating signals:

a) detecting the force to drive the crop cutting component 6 of the harvesting machine and generating a cutting force signal;

b) detecting the force to drive the crop conveying and/or processing component 7 of the harvesting machine and generating a friction force signal;

c) detecting a moisture of the crop and generation of a moisture signal; wherein the at least two generated signals are evaluated and wherein the development of the straw toughness of the crop and/or a friction value of the crop is determined based on the evaluated signals.

The crop properties straw toughness and friction value are important for mechanical processing during harvest. Furthermore, the properties of the crop are influenced by by-vegetation, such as weeds. This can affect the toughness and frictional properties of the non-grain constituents, consisting of straw, chaff, rachides and weeds. In addition, the ratio between grain ingredients and non-grain ingredients is changed. The more moist and less mature a cereal plant is, the more difficult it is to remove the grain from the ear. In addition, the dislodged grain is less able to penetrate a straw mat of moist and tough stalks. Weeds in the crop enhance this effect. Higher moisture on the stalk results in poorer friction properties and, in extreme cases, in grains sticking to the straw. The centrifugal forces and gravity may no longer be sufficient to separate enough grains from the straw mat. As a result, crop losses are increasing. As a countermeasure, the threshing drum speed can be increased and the threshing gap reduced. The increase in speed results in more blows to thresh out the grain and the centrifugal forces for separation increase. However, higher processing intensity also increases the risk of broken grain and, in conjunction with the higher friction value of the non-grain constituents, the risk of blockages and material flow disturbances increases. Dry crop has a better ability to release the grains from the ear, but the grains break more quickly due to mechanical stress. Dry or friable straw is also more brittle and must not be overly strained in the threshing drum. Otherwise, short straw is produced, which pollutes the cleaning elements of the harvesting machine. To maintain threshing quality with low losses, the processing intensity in the threshing drum can be reduced.

Moisture in the non-grain constituents of the crop may have several causes. If a plant is not completely dead and dried out at the time of harvest, the plant has green fibers and its own water balance. Due to the green fibers, the plant can have a high toughness as well as higher friction values, e.g. due to a wax layer, and can thus be more difficult to process mechanically. Another cause of increased moisture content may be the absorption of water by weathering. Dead plant parts can absorb water through humidity, rain or dew. In this case, the friction value of the non-grain constituents may increase. A moisture measurement to determine the moisture content of the crop, e.g. by conductivity measurement, only gives a signal for the water content. It is therefore not possible to draw any conclusions about the cause of the moisture. Thus, the toughness or friction properties of the crop cannot be directly inferred from a pure moisture measurement. By evaluating at least two of the signals cutting force signal, friction force signal and moisture signal, on the other hand, the development of the straw toughness of the crop and/or the friction value of the crop can be advantageously concluded. The evaluation of all three signals advantageously allows a more precise determination of the development.

One embodiment of the method for determining crop characteristics is described with reference to FIG. 2, which shows a field 10. The process may include the following steps:

determine growth zones of the field 10 from preliminary information in the form of map material from a remote sensing depending on the geographical position.

division of the field 10 into growth zones 11, 12, 13, 14, within each of which the same vegetation growth conditions prevail.

evaluation of the time course of vegetation index and maturation, and evaluation of the vegetation index of weeds after maturation. Optionally, yield mapping from past harvests can be used as additional map material.

The real properties of the crop are determined under harvesting conditions by measurement data from a drive power of a crop-separating, translational cutting system as a function of geographical position. Other sensor data from the harvesting machine, such as ground speed, grain yield or grain losses, can be included in the determination. The drive power of the cutting system is evaluated as a function of the knife position. The cutting performance can be determined from the performance curve, from which the development of the crop throughput can be estimated. In addition, the ratio of the cutting power in relation to the power in overstroke is evaluated, from which the development of the crop toughness can be derived. From the evaluation of the cutting system power in combination with travel speed and grain throughput, the stand density of the respective geographical location in the field can be determined. The resolution can be increased with the cutting system power. A measure of stand maturation and weediness due to green growth can be determined from the evaluation of crop toughness combined with cutting system power and stand density.

From the preliminary information on crop density data, maturation and weediness, the respective harvesting situation can be divided into classes, in which components of the harvesting machine are set differently in order to achieve an optimal working result in the respective situation. Possible class are: Average harvest conditions, light harvest conditions in drier or thinner stands, heavy harvest conditions in high stand density or later maturation, weeds in green growth.

To assign the expected harvesting conditions in the growth zones 11, 12, 13, 14, the classification of the crop is assigned to the harvesting conditions on site for the respective growth zone 11, 12, 13, 14 when the harvesting machine passes along a first lane through one of the growth zones 11, 12, 13, 14 determined by means of the map material from the preliminary information. The classification is matched with the geographical location and map material. Multiple growth zones 11, 12, 13, 14 are classified by means of traversing. The harvesting machine can thus already be adjusted in advance when passing along the second lane 16 during the change of a growth zone. Classification of growth zones 11, 12, 13, 14 and assignment of stand characteristics can also be done using prior information in the form of satellite data. Classification based on the data obtained by the cutting force sensor, the friction force sensor and the moisture sensor can verify the correct classification, correct it if necessary, or increase the resolution.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### List of Reference Numbers

1 Cutting force sensor

2 Frictional force sensor

3 Moisture sensor

4 Evaluation device

5 Data lines

6 Crop cutting component

7 Crop conveying and/or processing component

10 Field

11 Growth Zone

12 Growth Zone

13 Growth Zone

14 Growth Zone

15 First lane

16 Second lane

1. A harvesting machine for processing crop, comprising a sensor arrangement having at least two of the following sensors for generating signals:
a cutting force sensor adapted to detect a force for driving at least one component of the harvesting machine cutting the crop and to generate a cutting force signal,
a friction force sensor adapted to detect a force for driving at least one component of the harvesting machine which conveys and/or processes the crop and to generate a friction force signal,
a moisture sensor adapted to detect a moisture of the crop and to generate a moisture signal, and an evaluation device adapted to evaluate the signals generated by the at least two sensors and to determine on the basis of the evaluation at least one of a development of a straw toughness of the crop and a friction value of the crop.

2. The harvesting machine according to claim 1, wherein the sensor arrangement comprises a position sensor, the position sensor being adapted to detect a knife position of the component cutting the crop and to output a position signal.

3. The harvesting machine according to claim 2, wherein the evaluation device is adapted to evaluate the cutting force signal as a function of the knife position of the component cutting the crop.

4. A method for determining properties of crop during processing of the crop with a harvesting machine, comprising at least two of the following steps a, b and c for generating signals:
a) detecting a force for driving at least one component of the harvesting machine cutting the crop and generating a cutting force signal;
b) detecting a force for driving at least one component of the harvesting machine conveying and/or processing the crop and generating a friction force signal,
c) detecting a moisture of the crop and generating a moisture signal; and wherein the at least two generated signals are evaluated and wherein a development of at least one of a development of a straw toughness of the crop and a friction value of the crop is determined based on the evaluated signals.

5. A method for determining properties of crop in a field, wherein preliminary information about the properties of the crop in a map of the field is compared with measurement data of the properties of the crop determined in the field when processing the crop with a harvesting machine, wherein at least one of the following steps a, b and c for generating signals is carried out for determining the measurement data:
a) detecting a force for driving at least one component of the harvesting machine cutting the crop and generating a cutting force signal;
b) detecting a force for driving at least one component of the harvesting machine conveying and/or processing the crop and generating a friction force signal,
c) detecting of a moisture of the crop and generating a moisture signal; and wherein the at least one generated signal is evaluated and wherein a development of at least one of a development of a straw toughness of the crop and a friction value of the crop is determined based on the evaluated signals.

6. The method according to claim 5, wherein a prediction map of the field with updated properties of the crop is created from the preliminary information and the measurement data.

7. The method according to claim 5, wherein the field is divided into a finite number of areas with matching growth conditions based on the preliminary information, wherein the measurement data for the entire area determined for the first time in one of the areas is compared with the preliminary information.

8. The method according to any one of claim 4, wherein, when evaluating the signals, the development of at least one of the straw toughness and the friction value is concluded on the basis of at least one of a change and a direction of the change and a gradient of the change of the respective signal.

9. The method according to one of claim 4, wherein the signals are repeatedly evaluated during an evaluation period, the respectively determined development of the straw toughness and the friction value being output at the end of the evaluation period.

10. The method according to any one of claim 4, wherein the evaluation of the cutting force signal and the moisture signal is carried out according to the following specifications:
in case of a change in the cutting force signal and a constant moisture signal, a constant straw toughness and a constant friction value is inferred;
in case of rectified changes of the cutting force signal and the moisture signal, a change of the straw toughness is inferred;
in case of a constant cutting force signal and a change in the moisture signal, a change in the friction value is inferred.

11. The method according to any one of claim 4, wherein the evaluation of the cutting force signal and the friction force signal is carried out according to the following specifications:
in case of changes in the cutting force signal and the friction force signal with the same change gradients, a constant straw toughness and a constant friction value are inferred;
in case of changes in the cutting force signal and the friction force signal, where a change gradient of the cutting force signal is greater than a change gradient of the friction force signal, a change in straw toughness is inferred;
in the case of changes in the cutting force signal and the friction force signal, where a change gradient of the friction force signal is greater than a change gradient of the cutting force signal, a change in the friction value is inferred.

12. The method according to any one of claim 4, wherein the evaluation of the cutting force signal, the friction force signal and the moisture signal is carried out according to the following specifications:
in case of changes in the cutting force signal and the friction force signal with the same change gradients and with a constant moisture signal, a constant straw toughness and a constant friction value are inferred;
in case of changes in the cutting force signal and the friction force signal, where a change gradient of the cutting force signal is greater than a change gradient of the friction force signal, and for changes in the moisture signal, a change in straw toughness is inferred;
in case of changes in the cutting force signal and the friction force signal, where a change gradient of the friction force signal is greater than a change gradient of the cutting force signal, and in case of change in the moisture signal, a change in the friction value is inferred.

13. The method according to one of the claim 4, wherein a knife position of the component cutting the crop is detected as a further parameter, the evaluation of the cutting force signal being carried out taking the knife position into account, the cutting force signal being evaluated only in knife positions in which crop is being cut.

14. The method according to claim 13, wherein the cutting force signal in knife positions in which no crop is cut is evaluated as a friction force signal indirectly representing the force for driving a component conveying the crop.
